(19) United States
(12) Patent Application Publication
(10) Pub. No.: US 2025/0284966 A1
(43) Pub. Date: Sep. 11, 2025

(54) TRAINING LARGE LANGUAGE MODELS WITHOUT INFORMATION LEAKAGE

(71) Applicant: SAP SE, Walldorf (DE)

(72) Inventors: Guenther Schindler, Heidelberg (DE); Manuel Zeise, Karlsruhe (DE)

(21) Appl. No.: 18/601,575

(22) Filed: Mar. 11, 2024

(51) Int. Cl. G06N 3/0895; G06N 3/047

(52) U.S. Cl. CPC G06N 3/0895; G06N 3/047

(57) ABSTRACT

LLMs can process input from various sources and handle natural language but they are prone to hallucinate non-existing information and may reproduce (or “leak”) input provided during training. Both hallucinations and leaks are undesirable. To reduce or avoid hallucination of non-existing data, systems and methods discussed herein use negative sampling. A training set is supplemented with examples in which non-existent data is requested and the LLM is trained not to create data to satisfy the request. To reduce or avoid memorization by the LLM of input data, systems and methods discussed herein use a modified loss function. Using the modified loss functions discussed herein, the LLM learns the relationship between the response and the input without learning the input itself. As a result, the trained LLM does not leak the input data.

### TECHNICAL FIELD

The subject matter disclosed herein generally relates to systems for training large language models (LLMs). More specifically, for systems for training LLMs while discouraging information leakage and hallucinations.

### BACKGROUND

An LLM is a type of deep learning algorithm. LLMs are typically large neural networks trained using a large volume of training data. Once trained, an LLM can perform a variety of natural language processing tasks. Typically, a user provides a text prompt to the LLM and receives a response from the LLM.

The training data may be confidential (e.g., business, medical, or financial data). Accordingly, the LLM may be instructed not to reveal the training data. Nonetheless, the training data may “leak” in response to cleverly prepared prompts.

An LLM will often value the form of a response more than the accuracy of the response. As a result, incorrect but plausible responses (termed “hallucinations”) may be generated by the LLM. In practical applications, hallucinations are undesirable.

### BRIEF DESCRIPTION OF THE DRAWINGS

FIG. 1 shows a network diagram illustrating an example network environment suitable for training LLMs without hallucination and information leakage.

FIG. 2 shows a block diagram of an LLM server, suitable for training LLMs without hallucination and information leakage.

FIG. 3 is a block diagram of a neural network, suitable for use as an LLM without hallucination and information leakage, according to some example embodiments.

FIG. 4 shows an illustration of an example database schema, suitable for training LLMs without hallucination and information leakage.

FIG. 5 shows an illustration of an example training prompt suitable for training LLMs without hallucination and information leakage.

FIG. 6 shows an illustration of an example output from an LLM in response to the example training prompt of FIG. 5.

FIG. 7 shows a flowchart illustrating operations of an example method suitable for training LLMs without hallucination and information leakage.

FIG. 8 shows a flowchart illustrating operations of an example method suitable for training LLMs without hallucination and information leakage.

FIG. 9 shows a block diagram showing one example of a software architecture for a computing device.

FIG. 10 shows a block diagram of a machine in the example form of a computer system within which instructions may be executed for causing the machine to perform any one or more of the methodologies discussed herein.

### DETAILED DESCRIPTION

Example methods and systems are directed to training LLMs without information leakage. LLMs can process input from various sources and handle natural language but they are prone to hallucinate non-existing information and may reproduce (or “leak”) input provided during training. Both hallucinations and leaks are undesirable. Hallucinations make the results of the LLM unreliable for users of the trained LLM. Leaks expose data that may be confidential, or result in the reproduction of copyrighted works that were used in training.

Initial training of an LLM may be performed on a large corpus of general-purpose documents. The LLM is then fine-tuned before being put to work on particular tasks. For example, a document information extraction (DOX) task extracts logical entities (e.g., businesses, products, prices, quantities, addresses, phone numbers, dates, and the like) from documents (e.g., invoices, purchase orders, order confirmations, emails, and the like). To fine-tune the LLM to perform the DOX task, a corpus of annotated documents are used. The annotated documents may include real-world confidential information, and thus need to be protected from leaking by the resulting LLM.

To reduce or avoid hallucination of non-existing data, systems and methods discussed herein use negative sampling. The training set is supplemented with examples in which non-existent data is requested and the LLM is trained not to create data to satisfy the request. In this context, a positive sample refers to an annotated document in which requested data exists and a response is expected and a negative sample refers to an annotated document in which requested data does not exist and no response is expected.

To reduce or avoid memorization by the LLM of input data, systems and methods discussed herein use a modified loss function. A loss function calculates an error for a response provided by a machine learning model. Based on the value of the loss function, internal variables of the LLM are modified, which will change the output produced by the LLM in the future. Using a standard loss function, the LLM learns the correct response for a particular input, which can include memorizing the input. Using the modified loss functions discussed herein, the LLM learns the relationship between the response and the input without learning the input itself. As a result, the trained LLM does not leak the input data.

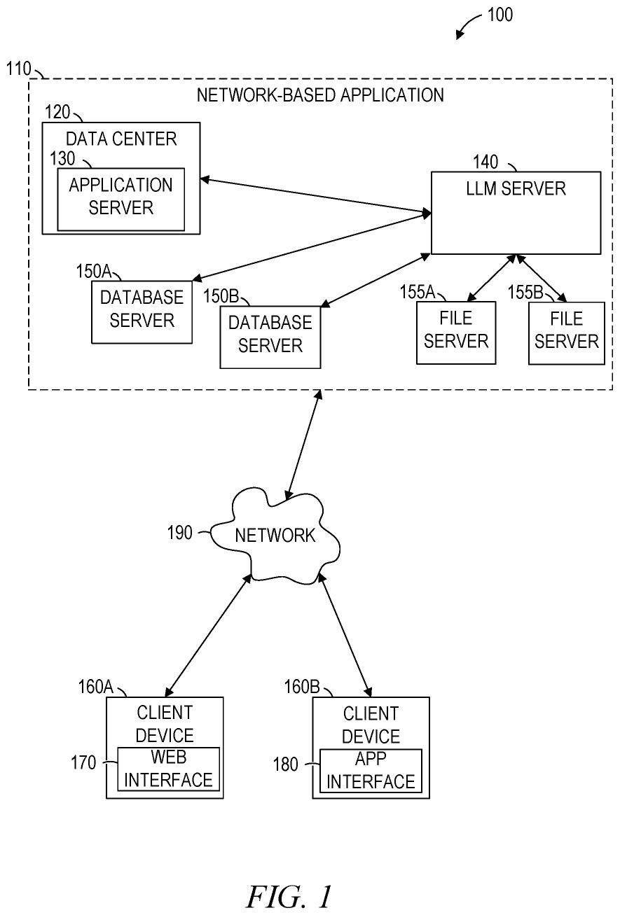

FIG. 1 shows a network diagram illustrating an example network environment 100 suitable for training LLMs without information leakage. The network environment 100 includes the network-based application 110, client devices 160A and 160B, and a network 190. The network-based application 110 is implemented at a data center 120 comprising an application server 130, in communication with an LLM server 140. The LLM server 140 gathers data from the database servers 150A and 150B and the file servers 155A and 155B. The LLM server 140, the file servers 155A-155B, the database servers 150A-150B, or any suitable combination thereof, may be part of the data center 120.

An application executing on the application server 130 accesses data from the LLM server 140. The LLM server 140 accesses and processes data from the database servers 150A-150B and the file servers 155A-155B. The LLM server 140 may be trained on data from the database servers 150A-150B and the file servers 155A-155B. Once trained, the application server 130 may provide prompts to the LLM server 140 and receive responsive output from the LLM server 140. For example, documents containing natural language information may be sent to the LLM server 140 for processing and reformatting into structured data (e.g., data in JavaScript Object Notation [JSON] format).

The application running on the application server 130 provides services to the client devices 160A and 160B. For example, a user of the client device 160A may be an employee of a business using a business application. The user may receive an email containing an invoice or order request in a natural language format. The user may request the application server 130 to process the email, extract the information into a structured format, and add the data to a database. The user interface for the application may be presented using a web interface 170 or an app interface 180.

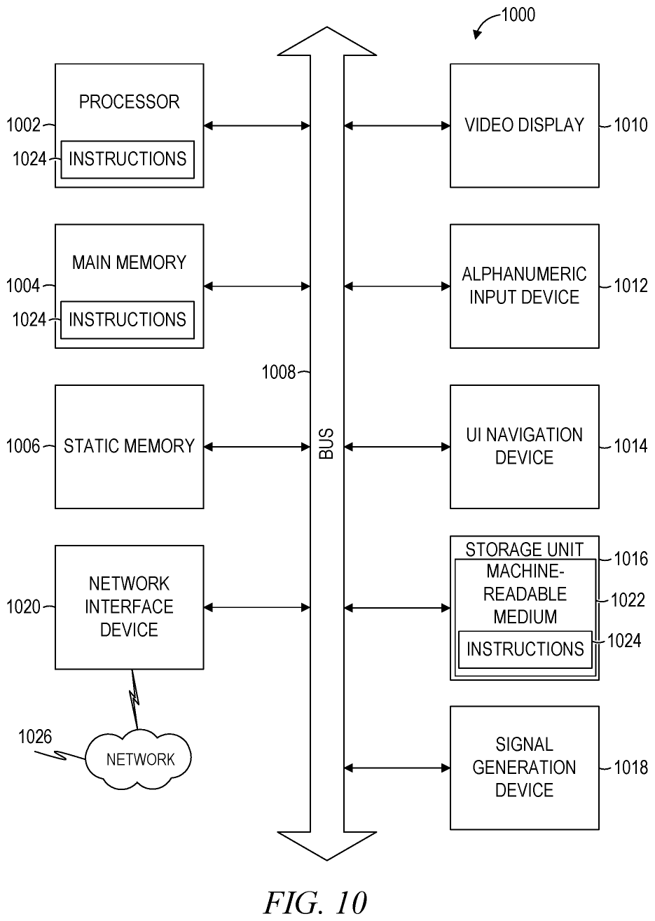

The application server 130, the LLM server 140, the file servers 155A-155B, the database servers 150A-150B, and the client devices 160A-160B may each be implemented in a computer system, in whole or in part, as described below with respect to FIG. 10. Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 10. As used herein, a “database” is a data storage resource and may store data structured as a text file, a table, a spreadsheet, a relational database (e.g., an object-relational database), a triple store, a hierarchical data store, a document-oriented NoSQL database, a file store, or any suitable combination thereof. The database may be an in-memory database. Moreover, any two or more of the machines, databases, or devices illustrated in FIG. 1 may be combined into a single machine, database, or device, and the functions described herein for any single machine, database, or device may be subdivided among multiple machines, databases, or devices.

The application server 130, the LLM server 140, the file servers 155A-155B, the database servers 150A-150B, and the client devices 160A-160B are connected by the network 190. The network 190 may be any network that enables communication between or among machines, databases, and devices. Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof.

Though FIG. 1 shows only one or two of each element (e.g., one application server 130, two client devices 160A and 160B, and the like), any number of each element is contemplated. For example, the application server 130 may be one of dozens or hundreds of active and standby servers and provide services to millions of client devices. Likewise, the LLM server 140 may access data from dozens or hundreds of database servers and file servers, be used by many application servers 130, and so on.

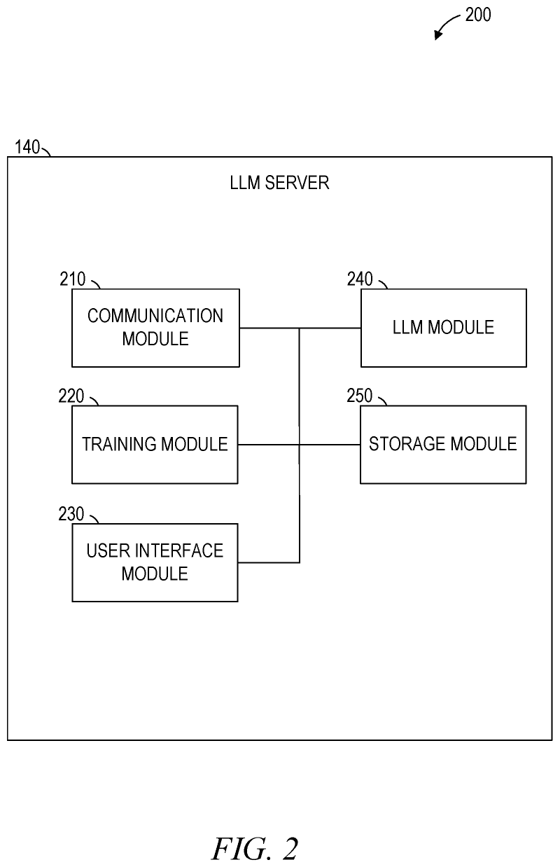

FIG. 2 shows a block diagram 200 of the LLM server 140, suitable for training LLMs without information leakage. The LLM server 140 is shown as including a communication module 210, a training module 220, a user interface module 230, an LLM module 240, and a storage module 250, all configured to communicate with each other (e.g., via a bus, shared memory, or a switch). Any one or more of the modules described herein may be implemented using hardware (e.g., a processor of a machine). For example, any module described herein may be implemented by a processor configured to perform the operations described herein for that module. Moreover, any two or more of these modules may be combined into a single module, and the functions described herein for a single module may be subdivided among multiple modules. Furthermore, modules described herein as being implemented within a single machine, database, or device may be distributed across multiple machines, databases, or devices.

The communication module 210 receives data sent to the LLM server 140 and transmits data from the LLM server 140. For example, the communication module 210 may receive, from the application server 130, a request to extract data from a natural language document and generate structured data. In response, the communication module 210 provides the natural language document to the LLM module 240. The communication module 210 may also send requests to the file servers 155A-155B and the database servers 150A-150B for training data to be used by the training module 220.

The training module 220 trains an LLM of the LLM module 240. The training includes providing a training set of annotated documents to the LLM. The training set may include positive and negative examples, to reduce the probability of hallucination. Training may use a loss function that distinguishes between input and response portions of interactions to reduce the probability of data leakage.

The LLM module 240 parses natural language documents to generate a structured representation of the data contained in the documents. For example, a document may contain the results of optical character recognition (OCR) of a printed invoice or an emailed invoice. The LLM module 240 generates, based on the document, structured data containing the information from the document. For example, a JSON object with predetermined fields may be created

Data, metadata, documents, instructions, or any suitable combination thereof may be stored and accessed by the storage module 250. For example, local storage of the LLM server 140, such as a hard drive, may be used. As another example, network storage may be accessed by the storage module 250 via the network 190.

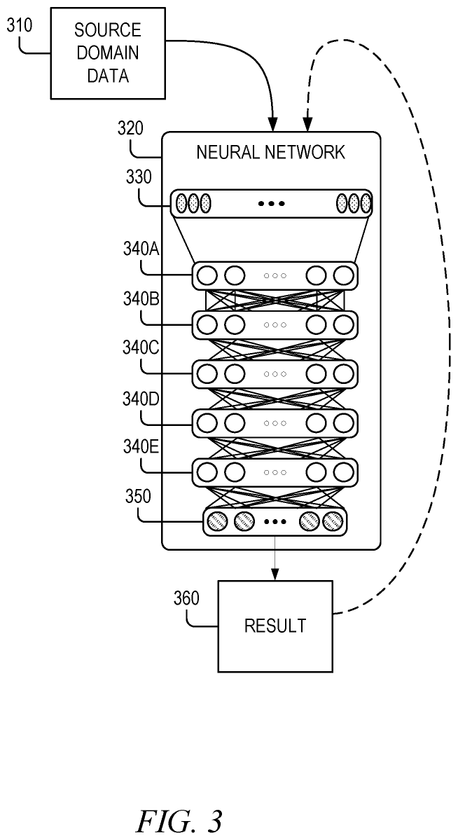

FIG. 3 is a block diagram of a neural network 320, suitable for use as an LLM without hallucination and information leakage, according to some example embodiments. The neural network 320 takes source domain data 310 as input and processes the source domain data 310 using the input layer 330; the intermediate, hidden layers 340A, 340B, 340C, 340D, and 340E; and the output layer 350 to generate a result 360.

A neural network, sometimes referred to as an artificial neural network, is a computing system based on consideration of biological neural networks of animal brains. Such systems progressively improve performance, which is referred to as learning, to perform tasks, typically without task-specific programming. For example, in image recognition, a neural network may be taught to identify images that contain an object by analyzing example images that have been tagged with a name for the object and having learned the object and name, may use the analytic results to identify the object in untagged images.

A neural network is based on a collection of connected units called neurons, where each connection, called a synapse, between neurons can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

Each of the layers 330-350 comprises one or more nodes (or “neurons”). The nodes of the neural network 320 are shown as circles or ovals in FIG. 3. Each node takes one or more input values, processes the input values using zero or more internal variables, and generates one or more output values. The inputs to the input layer 330 are values from the source domain data 310. The output of the output layer 350 is the result 360. The intermediate layers 340A-340E are referred to as “hidden” because they do not interact directly with either the input or the output and are completely internal to the neural network 320. Though five hidden layers are shown in FIG. 3, more or fewer hidden layers may be used.

A model may be run against a training dataset for several epochs, in which the training dataset is repeatedly fed into the model to refine its results. In each epoch, the entire training dataset is used to train the model. Multiple epochs (e.g., iterations over the entire training dataset) may be used to train the model. In some example embodiments, the number of epochs is 10, 100, 500, or 1000. Within an epoch, one or more batches of the training dataset are used to train the model. Thus, the batch size ranges between 1 and the size of the training dataset while the number of epochs is any positive integer value. The model parameters are updated after each batch (e.g., using gradient descent).

For self-supervised learning, the training dataset comprises self-labeled input examples. For example, a set of color images could be automatically converted to black-and-white images. Each color image may be used as a “label” for the corresponding black-and-white image and used to train a model that colorizes black-and-white images. This process is self-supervised because no additional information, outside of the original images, is used to generate the training dataset. Similarly, when text is provided by a user, one word in a sentence can be masked and the network trained to predict the masked word based on the remaining words.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the nth epoch, the learning phase may end early and use the produced model satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs—having reached a performance plateau—the learning phase for the given model may terminate before the epoch number/computing budget is reached.

Once the learning phase is complete, the models are finalized. In some example embodiments, models that are finalized are evaluated against testing criteria. In a first example, a testing dataset that includes known outputs for its inputs is fed into the finalized models to determine an accuracy of the model in handling data that it has not been trained on. In a second example, a false positive rate or false negative rate may be used to evaluate the models after finalization. In a third example, a delineation between data clusters is used to select a model that produces the clearest bounds for its clusters of data.

The neural network 320 may be a deep learning neural network, a deep convolutional neural network, a recurrent neural network, a transformer neural network, or another type of neural network. A neuron is an architectural element used in data processing and artificial intelligence, particularly machine learning. A neuron implements a transfer function by which a number of inputs are used to generate an output. In some example embodiments, the inputs are weighted and summed, with the result compared to a threshold to determine if the neuron should generate an output signal (e.g., a 1) or not (e.g., a 0 output). The inputs of the component neurons are modified through the training of a neural network. One of skill in the art will appreciate that neurons and neural networks may be constructed programmatically (e.g., via software instructions) or via specialized hardware linking each neuron to form the neural network.

An example type of layer in the neural network 320 is a Long Short Term Memory (LSTM) layer. An LSTM layer includes several gates to handle input vectors (e.g., time-series data), a memory cell, and an output vector. The input gate and output gate control the information flowing into and out of the memory cell, respectively, whereas forget gates optionally remove information from the memory cell based on the inputs from linked cells earlier in the neural network. Weights and bias vectors for the various gates are adjusted over the course of a training phase, and once the training phase is complete, those weights and biases are finalized for normal operation.

A deep neural network (DNN) is a stacked neural network, which is composed of multiple layers. The layers are composed of nodes, which are locations where computation occurs, loosely patterned on a neuron in the human brain, which fires when it encounters sufficient stimuli. A node combines input from the data with a set of coefficients, or weights, that either amplify or dampen that input. Thus, the coefficients assign significance to inputs for the task the algorithm is trying to learn. These input-weight products are summed, and the sum is passed through what is called a node's activation function, to determine whether and to what extent that signal progresses further through the network to affect the ultimate outcome. A DNN uses a cascade of many layers of non-linear processing units for feature extraction and transformation. Each successive layer uses the output from the previous layer as input. Higher-level features are derived from lower-level features to form a hierarchical representation. The layers following the input layer may be convolution layers that produce feature maps that are filtering results of the inputs and are used by the next convolution layer.

In training of a DNN architecture, a regression, which is structured as a set of statistical processes for estimating the relationships among variables, can include a minimization of a cost function. The cost function may be implemented as a function to return a number representing how well the neural network performed in mapping training examples to correct output. In training, if the cost function value is not within a pre-determined range, based on the known training images, backpropagation is used, where backpropagation is a common method of training artificial neural networks that are used with an optimization method such as a stochastic gradient descent (SGD) method.

Use of backpropagation can include propagation and weight updates. When an input is presented to the neural network, it is propagated forward through the neural network, layer by layer, until it reaches the output layer. The output of the neural network is then compared to the desired output, using the cost function, and an error value is calculated for each of the nodes in the output layer. The error values are propagated backwards, starting from the output, until each node has an associated error value which roughly represents its contribution to the original output. Backpropagation can use these error values to calculate the gradient of the cost function with respect to the weights in the neural network. The calculated gradient is fed to the selected optimization method to update the weights to attempt to minimize the cost function.

In some example embodiments, the structure of each layer is predefined. For example, a convolution layer may contain small convolution kernels and their respective convolution parameters, and a summation layer may calculate the sum, or the weighted sum, of two or more values. Training assists in defining the weight coefficients for the summation.

One way to improve the performance of DNNs is to identify newer structures for the feature-extraction layers, and another way is by improving the way the parameters are identified at the different layers for accomplishing a desired task. For a given neural network, there may be millions of parameters to be optimized. Trying to optimize all these parameters from scratch may take hours, days, or even weeks, depending on the amount of computing resources available and the amount of data in the training set.

One of ordinary skill in the art will be familiar with several machine learning algorithms that may be applied with the present disclosure, including linear regression, random forests, decision tree learning, neural networks, DNNs, genetic or evolutionary algorithms, and the like.

With the help of natural language processing (NLP) and advanced data pre-processing, a machine learning model (e.g., the neural network 320) can be trained on all historical (existing) business entities (for instance, incidents, email interactions, etc.) from the system to assign them with a certain set of keywords or a dominant topic label based on textual fields such as description, subject, and so forth.

A topic label can be a human-readable phrase or word specific to the industry that it belongs to. It can be determined based on a set of keywords. For instance, if an object contains a long text of multiple words, this model will detect the most “relevant” and “important” keywords and assign them to different ensembles based on multiple factors. Some factors include feature importance and linguistic proximity. Feature importance is an NLP technique used to determine the most important and relevant textual fields provided from an input. Linguistic proximity refers to a distance between vector representations of keywords in two (or more) textual inputs. Additional factors include word commonalities, n-gram commonalities, and the like.

Related data objects may be assigned a human-legible “topic.” Based on the existing topics and the contents of a new data object, the new data object is automatically assigned to one of the existing topics.

The transformer architecture processes an entire input at once rather than sequentially. For example, a RNN processes words or sentences sequentially, with the output of the RNN treated as an input for each input after the first (thus the use of the word “recurrent” in the name). As a result, relationships between elements that are far apart in the input are difficult to detect. The transformer architecture receives a larger input and learns the interrelationships between the elements and the output using an attention mechanism. Since all elements are processed together, distance between the elements of the input does not affect the learning process. The output may still be generated sequentially, with the previous result (e.g., word for an LLM, pixel for an image-generating AI, and the like) being provided as an input for determination of the next result.

The neural network 320 may be used for extracting data values from unstructured data and providing the extracted data values in structured data. For example, the training data may include inputs comprising instructions for data extraction and unstructured data. The corresponding outputs may be the expected structured data results. After training, when the neural network receives instructions and unstructured data as input, it generates structured data as output.

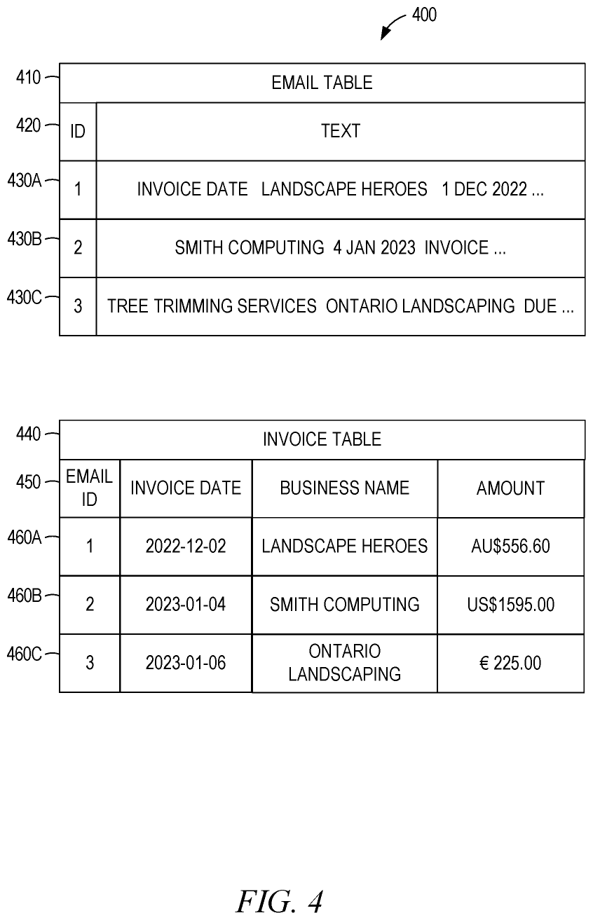

FIG. 4 shows an illustration of an example database schema 400, suitable for training LLMs without information leakage. The database schema 400 includes an email table 410 and an invoice table 440. The email table 410 includes rows 430A, 430B, and 430C of a format 420. The invoice table 440 includes rows 460A, 460B, and 460C of a format 450.

Each of the rows 430A-430C of the email table 410 includes a unique identifier for an email and text of the email, as indicated by the format 420. In the example of FIG. 4, each of the emails of the email table 410 includes a natural language invoice.

The format 450 of the invoice table 440 indicates that each of the rows 460A-460C includes an identifier of an email used to generate the row, a date of an invoice, a name of the business that issued the invoice, and an amount of the invoice. Each of the rows 460A-460C may be populated with structured data generated by the LLM server 140 in response to a prompt that includes the text of an email.

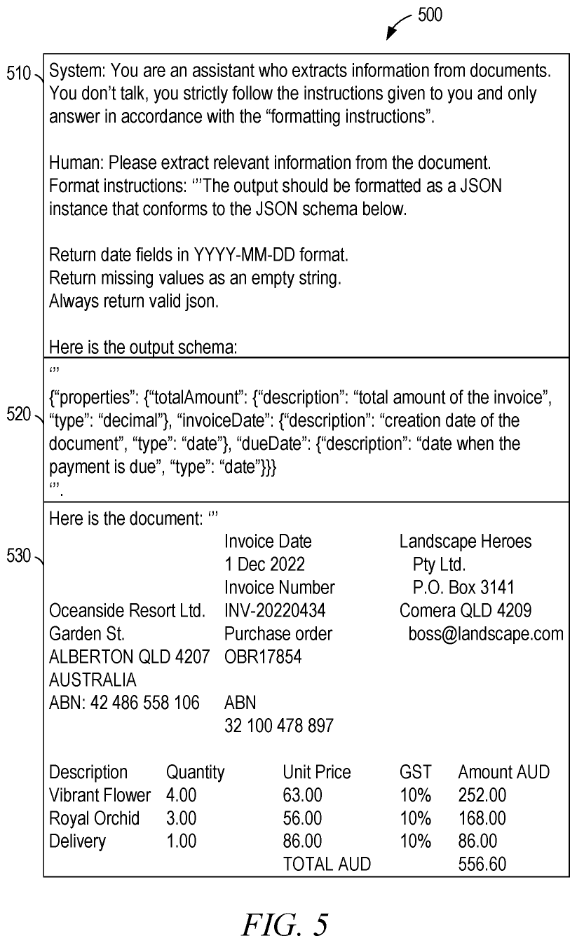

FIG. 5 shows an illustration of an example training prompt 500 suitable for training LLMs without information leakage. The example training prompt 500 includes portions 510, 520, and 530. The portion 510 includes general instructions, the portion 520 includes an output schema definition, and the portion 530 includes text of an input document.

The general instructions of the portion 510 instruct the LLM to only generate output according to the output schema definition, avoiding other outputs and the generation of artificial data values when data is not found in the input document. The output schema definition of the portion 520 instructs the LLM as to the format of the structured data to produce based on the input document. The input document of the portion 530 includes unstructured data from which data values are extracted by the LLM to generate the structured data. The input document may be generated by using OCR on a printed document, by copying an electronic document (e.g., an email, a PDF file, a Word file, or any suitable combination thereof), or any suitable combination thereof.

In some example embodiments, the portions 510-530 appear in different orders. For example, the portion 530 may be presented first, followed by the portion 510 and then the portion 520. As another example, a first part of the portion 510 may appear before the portion 520 and a second part of the portion 510 may appear after the portion 520.

By training an LLM using training prompts of the format of the training prompt 500, the LLM learns to extract data from documents without hallucinating values that are not present in the documents. As a result, the trained LLM is less likely to hallucinate values than LLMs that do not use such training prompts, improving the utility of the resulting LLM.

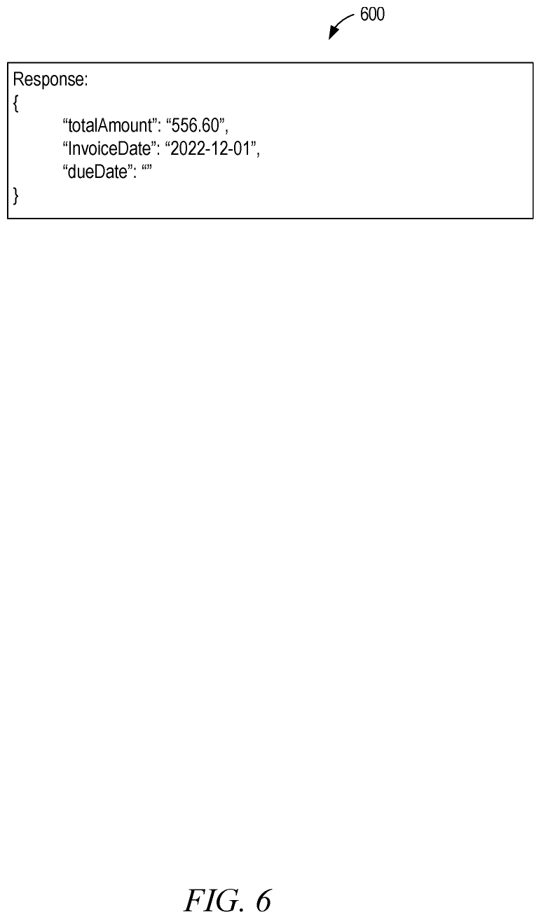

FIG. 6 shows an illustration of an example output 600 from an LLM in response to the example training prompt of FIG. 5. As instructed by the general instructions of the portion 510, the example output 600 does not include extraneous conversation, but only includes a JSON instance. The generated JSON instance follows the output schema defined in the portion 520, and includes a totalAmount, an invoiceDate, and a dueDate. The LLM has extracted the values for the three fields from the document of the portion 530.

In this example, the output is generated in response to a training prompt, but a similar prompt may be used with a document in a production environment. For example, a user of the client device 160A of FIG. 1 may send an email with an invoice to the application server 130, also of FIG. 1. The application server 130 may store the email in the email table 410 of FIG. 4 when the email is received. At the time the email is received or at a later time, by retrieving the email from the email table 410, the application server 130 generates a prompt similar to the example training prompt 500 and provides the generated prompt to the LLM server 140 of FIG. 1. In response to the prompt, the LLM server 140 generates output similar to the example output 600 of FIG. 6 and provides the generated JSON instance to the application server 130, for processing by an application. The application may retrieve the data values from the JSON instance and add a row to the invoice table 440 of FIG. 4.

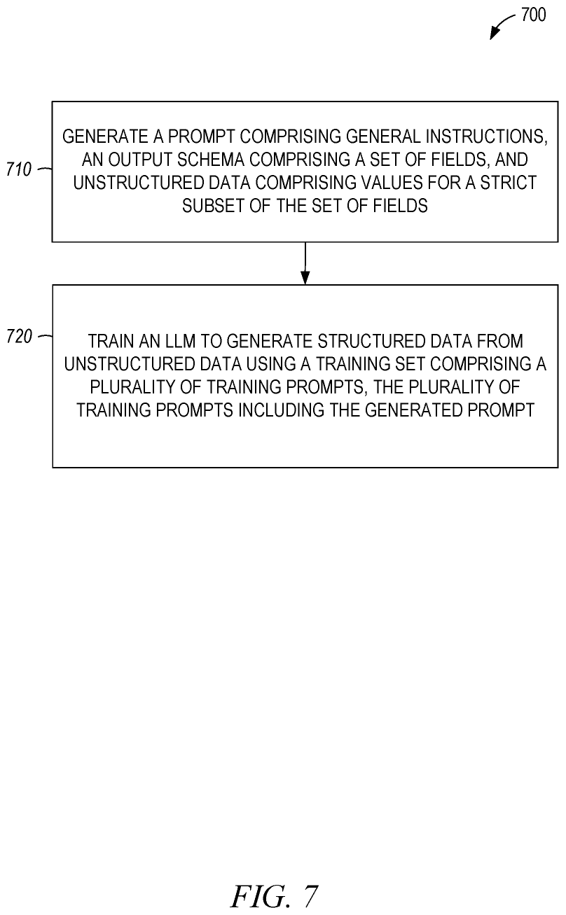

FIG. 7 shows a flowchart illustrating operations of an example method 700 suitable for training LLMs without hallucination and information leakage. The method 700 includes operations 710 and 720. By way of example and not limitation, the method 700 is described as being performed by the LLM server 140 of FIG. 1, using the modules of FIG. 2, and the example training prompt 500 of FIG. 5.

In operation 710, the training module 220 of the LLM server 140 generates a prompt comprising general instructions, an output schema comprising a set of fields, and unstructured data comprising values for a strict subset of the set of fields. The example training prompt 500 is such a prompt, with general instructions in the portion 510, an output schema comprising three fields in the portion 520, and unstructured data comprising values for a strict subset of the set of fields in the portion 530. A strict subset is a subset that is smaller than the set of which it is a subset. In this example, the portion 530 does not contain a date when the payment is due. As a result of the general instructions instructing the LLM to return missing values as an empty string and the portion 530 not including a due date, the example output 600 of FIG. 6 does not include a value for the dueDate field.

The fields that are in the set of fields and not in the strict subset of the set of fields are negative fields. The fields that are in the strict subset of the set of fields are positive fields. In some example embodiments, the number of positive fields is pre-determined, the number of negative fields is pre-determined, or both are pre-determined.

The LLM module 240 of the LLM server 140 trains an LLM to generate structured data from unstructured data using a training set comprising a plurality of training prompts, the plurality of training prompts including the generated prompt (operation 720). The training set may comprise dozens, hundreds, or thousands of training prompts. Some of the training prompts may include unstructured data comprising values for all fields of the output schema of the training prompt. In some example embodiments, each output schema field has at least one corresponding training prompt that includes unstructured data without the output schema field.

In example embodiments using a pre-determined number of positive fields, each training prompt in the training set may comprise the pre-determined number of positive fields. The specific fields that are positive for each training prompt may vary (e.g., be randomly chosen). In example embodiments using a pre-determined number of negative fields, each training prompt in the training set may comprise the pre-determined number of negative fields. The specific fields that are negative for each training prompt may vary (e.g., be randomly chosen). For example, the training module 220 may randomly select from the set of fields, for each training prompt of a plurality training prompts in the training set, the pre-determined number of positive fields to include in the training prompt (e.g., in the output schema of the training prompt).

Instead of using a pre-determined number of positive or negative fields, the training module 220 may determine, according to a probability distribution (e.g., a Poisson distribution, a Pareto distribution, a geometric distribution, or any suitable combination thereof), a number of positive fields to include and a number of negative fields to exclude for each training prompt. In such embodiments, the training module 220 generates each training prompt to include general instructions, an output schema comprising a set of fields, and unstructured data comprising values for the determined number of positive fields and excluding values for the determined number of negative fields.

The unstructured data may be provided by users rather than being specifically generated for testing. In this case, it may be difficult to generate or select unstructured data with particular numbers and types of positive and negative fields. Accordingly, the modifying of the number and type of positive and negative fields in a particular prompt may be accomplished by modifying the output schema to request values that are present in the unstructured data (positive fields) and values that are not present in the unstructured data (negative fields).

After training an LLM using the method 700, the LLM is less likely to hallucinate non-existing values than an LLM trained using a training set in which all data fields are present. As a result, the generated LLM is more reliable than previous LLMs.

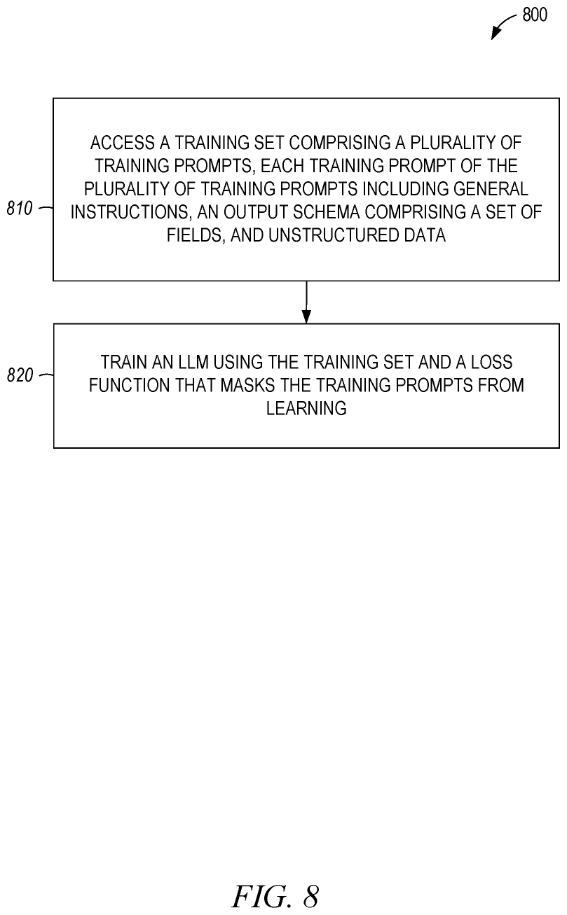

FIG. 8 shows a flowchart illustrating operations of an example method 800 suitable for training LLMs without hallucination and information leakage. The method 800 includes operations 810 and 820. By way of example and not limitation, the method 800 is described as being performed by the LLM server 140 of FIG. 1, using the modules of FIG. 2, and the example training prompt 500 of FIG. 5.

In operation 810, the training module 220 accesses a training set comprising a plurality of training prompts. Each training prompt of the plurality of training prompts includes general instructions, an output scheme comprising a set of fields, and unstructured data. The example training prompt 500 is such a training prompt.

The training module 220, in operation 820, trains an LLM using the training set and a loss function that masks the training prompts from learning. Using a standard loss function, the LLM learns the correct response for a particular input, which can include memorizing the input. Using a loss function that masks the training prompts from learning, the LLM learns the relationship between the response and the input without learning the input itself. As a result, the trained LLM does not leak the input data.

The negative sampling discussed with respect to the method 700 of FIG. 7 suppresses the LLM's ambition to generate responses when the queried information is not contained in the document and, hence, prevents query attacks on the model. However, the negative sampling does not prevent more complex next-token attacks.

LLMs are commonly implemented via autoregressive language modelling (often referred to as causal language modelling) where the prediction of the next word in a sequence is conditioned on the words that have come before it. For example, consider the following example “The cat sat on the ______.” An autoregressive model will take as input “The cat sat on the” and will output the probability distribution over possible next words, such as “sofa”, “floor”, “roof”, and the like.

An attacker may use this conditioning to extract training data from the model by synthesizing sequences of words and obtaining the probability distribution for the next words. For example, consider the attacker wants to extract the supplier number of company XYZ, an example attack may contain following sequence of words “XYZ GmbH\nSome Street 42\nCityville 12345\nSupplierID:.” In this example, an attacker uses public data of company XYZ (e.g., an address) to synthesize sequences to obtain the probability distribution for the non-public supplier number of the company. This can lead to a successful attack if the supplier number of company XYZ was provided during training. This is referred to as a “next-token attack.”

As illustrated in FIG. 5, the training prompts for DOX comprise an instruction part (e.g., the portions 510 and 520) and a document part (e.g., the portion 530). For training, the LLM is also provided the expected response based on the provided document and instructions. More formally, the instruction part comprises an instruction sequence of words (w₁, w₂, . . . , w_{I}), the document part comprises a document sequence of words (w_{I+1}, w_{I+2}, . . . , w_{I+D}), and the response comprises a response sequence of words (w_{I+D+1}, w_{I+D+2}, . . . , w_{I+D+R}), where I, D, and R are the length of the tokenized word vectors for instructions, document, and response, respectively. An autoregressive language model factorizes the joint probability P(w₁, w₂, . . . , w_{I+D+R}) as the product of conditional probabilities:

$$P ( {w}_{1} , {w}_{2} , … , {w}_{I + D + R} ) = P ( {w}_{1} ) \cdot P ( {w}_{2} \vert {w}_{1} ) \cdot P ( {w}_{3} \vert {w}_{1} , {w}_{2} ) \cdot … \cdot P ( {w}_{I + D + R} \vert {w}_{1} , … , {w}_{I + D + R - 1} ) .$$

The goal in training an autoregressive language model is to maximize the likelihood of the observed data (training data) and the corresponding loss function for the model is the negative log likelihood of the sequence of words as:

$$L = - \frac{1}{I + D + R} \cdot ( log ( P ( {w}_{1} ) ) + log ( P ( {w}_{2} \vert {w}_{1} ) ) + log ( P ( {w}_{3} \vert {w}_{1} , {w}_{2} ) ) + … + log ( P ( {w}_{I + D + R} \vert {w}_{1} , … , {w}_{I + D + R - 1} ) )$$

Using the above loss function results in models that learn the joint probability distribution of the entire prompt sequence (w₁, w₂, . . . , w_{I+D+R}) and are consequently prone to next-token attacks. An attacker could potentially extract data from instructions as well as documents used for optimization.

Instead, in operation 820, a loss function such as the one below is used.

$$L = - \frac{1}{R} \cdot ( log ( P ( {w}_{I + D + 1} ) \vert {w}_{1} , … , {w}_{I + D} + log ( P ( {w}_{I + D + 2} \vert {w}_{1} , … , {w}_{I + D + 1} ) ) + log ( \text{} P ( {w}_{I + D + 2} \vert {w}_{1} , … , {w}_{I + D + 3} ) ) + … + log ( P ( {w}_{I + D + R} \vert {w}_{1} , … , {w}_{I + D + R - 1} ) )$$

This approach can also be seen as masking instructions and documents in the loss calculation. As a result, only the joint probability of the response P(w_{I+D+1}, w_{I+D+2}) . . . , w_{I+D+R}) is optimized on the observed data while P(w₁, w₂, . . . , w_{I+D}) is independent from the observed data. Next-token attacks on instructions or OCR documents are consequently successfully prevented and leakage of training data is avoided.

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: a memory that stores instructions; and one or more processors coupled to the memory and configured to execute the instructions to perform operations comprising: generating a prompt comprising general instructions, an output schema comprising a set of fields, and unstructured data comprising values for a strict subset of the set of fields; and training a large language model (LLM) to generate structured data from unstructured data using a training set comprising a plurality of training prompts, the plurality of training prompts including the generated prompt.

In Example 2, the subject matter of Example 1, wherein the operations further comprise: accessing a pre-determined number of positive fields to include in the output schema; and accessing a pre-determined number of negative fields to exclude from the output schema.

In Example 3, the subject matter of Example 2, wherein the operations further comprise: generating a plurality of additional training prompts, each training prompt of the plurality of additional training prompts comprising general instructions, an output schema comprising a set of fields, and unstructured data comprising values for the pre-determined number of positive fields and excluding values for the pre-determined number of negative fields; and including the plurality of additional training prompts in the plurality of training prompts.

In Example 4, the subject matter of Example 3, wherein the operations further comprise: randomly selecting, for each training prompt of the plurality of additional training prompts, from the set of fields, the pre-determined number of positive fields to include.

In Example 5, the subject matter of Examples 1-4, wherein the operations further comprise: generating a plurality of additional training prompts, by operations comprising, for each training prompt of the plurality of additional training prompts: determining, according to a probability distribution, a number of positive fields to include and a number of negative fields to exclude; and generating the training prompt of the plurality of additional training prompts to include general instructions, an output schema comprising a set of fields, and unstructured data comprising values for the determined number of positive fields and excluding values for the determined number of negative fields; and including the plurality of additional training prompts in the plurality of training prompts.

In Example 6, the subject matter of Example 5, wherein the probability distribution is a Poisson distribution.

In Example 7, the subject matter of Examples 1-6, wherein the training of the LLM uses a loss function that masks the training prompts from learning.

Example 8 is a non-transitory computer-readable medium that stores instructions that, when executed by one or more processors, cause the one or more processors to perform operations comprising: generating a prompt comprising general instructions, an output schema comprising a set of fields, and unstructured data comprising values for a strict subset of the set of fields; and training a large language model (LLM) to generate structured data from unstructured data using a training set comprising a plurality of training prompts, the plurality of training prompts including the generated prompt.

In Example 9, the subject matter of Example 8, wherein the operations further comprise: accessing a pre-determined number of positive fields to include in the output schema; and accessing a pre-determined number of negative fields to exclude from the output schema.

In Example 10, the subject matter of Example 9, wherein the operations further comprise: generating a plurality of additional training prompts, each training prompt of the plurality of additional training prompts comprising general instructions, an output schema comprising a set of fields, and unstructured data comprising values for the pre-determined number of positive fields and excluding values for the pre-determined number of negative fields; and including the plurality of additional training prompts in the plurality of training prompts.

In Example 11, the subject matter of Example 10, wherein the operations further comprise: randomly selecting, for each training prompt of the plurality of additional training prompts, from the set of fields, the pre-determined number of positive fields to include.

In Example 12, the subject matter of Examples 8-11, wherein the operations further comprise: generating a plurality of additional training prompts, by operations comprising, for each training prompt of the plurality of additional training prompts: determining, according to a probability distribution, a number of positive fields to include and a number of negative fields to exclude; and generating the training prompt of the plurality of additional training prompts to include general instructions, an output schema comprising a set of fields, and unstructured data comprising values for the determined number of positive fields and excluding values for the determined number of negative fields; and including the plurality of additional training prompts in the plurality of training prompts.

In Example 13, the subject matter of Example 12, wherein the probability distribution is a Poisson distribution.

In Example 14, the subject matter of Examples 8-13, wherein the training of the LLM uses a loss function that masks the training prompts from learning.

Example 15 is a method comprising: generating, by one or more processors, a prompt comprising general instructions, an output schema comprising a set of fields, and unstructured data comprising values for a strict subset of the set of fields; and training a large language model (LLM) to generate structured data from unstructured data using a training set comprising a plurality of training prompts, the plurality of training prompts including the generated prompt.

In Example 16, the subject matter of Example 15 includes accessing a pre-determined number of positive fields to include in the output schema; and accessing a pre-determined number of negative fields to exclude from the output schema.

In Example 17, the subject matter of Example 16 includes generating a plurality of additional training prompts, each training prompt of the plurality of additional training prompts comprising general instructions, an output schema comprising a set of fields, and unstructured data comprising values for the pre-determined number of positive fields and excluding values for the pre-determined number of negative fields; and including the plurality of additional training prompts in the plurality of training prompts.

In Example 18, the subject matter of Example 17 includes randomly selecting, for each training prompt of the plurality of additional training prompts, from the set of fields, the pre-determined number of positive fields to include.

In Example 19, the subject matter of Examples 15-18 includes generating a plurality of additional training prompts, by operations comprising, for each training prompt of the plurality of additional training prompts: determining, according to a probability distribution, a number of positive fields to include and a number of negative fields to exclude; and generating the training prompt of the plurality of additional training prompts to include general instructions, an output schema comprising a set of fields, and unstructured data comprising values for the determined number of positive fields and excluding values for the determined number of negative fields; and including the plurality of additional training prompts in the plurality of training prompts.

In Example 20, the subject matter of Example 19, wherein the probability distribution is a Poisson distribution.

Example 21 is an apparatus comprising means to implement any of Examples 1-20.

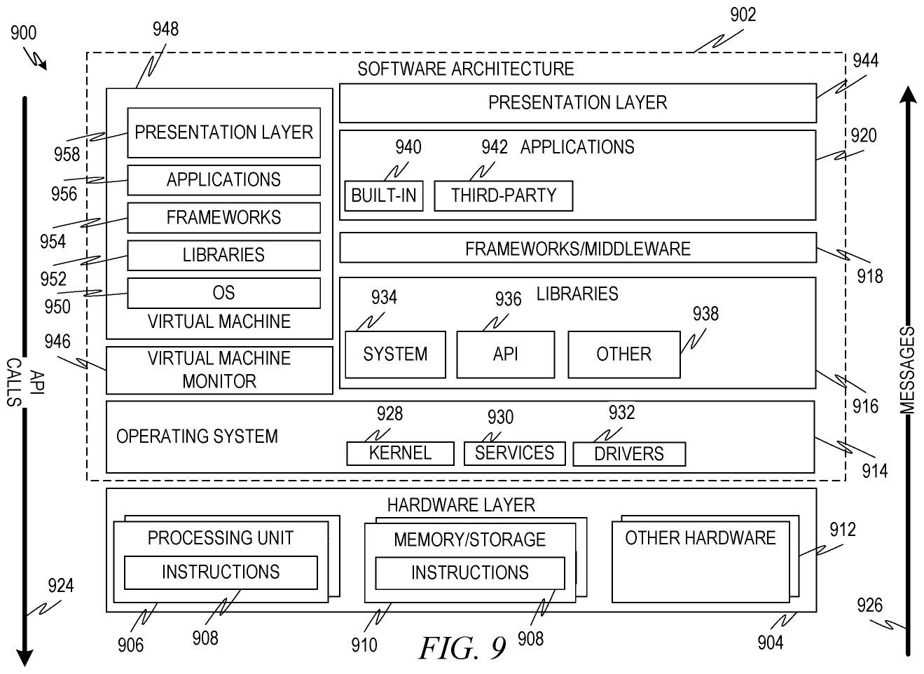

FIG. 9 shows a block diagram 900 showing one example of a software architecture 902 for a computing device. The software architecture 902 may be used in conjunction with various hardware architectures, for example, as described herein. FIG. 9 is merely a non-limiting example of a software architecture, and many other architectures may be implemented to facilitate the functionality described herein. A representative hardware layer 904 is illustrated and can represent, for example, any of the above referenced computing devices. In some examples, the hardware layer 904 may be implemented according to the architecture of the computer system of FIG. 9.

The representative hardware layer 904 comprises one or more processing units 906 having associated executable instructions 908. Executable instructions 908 represent the executable instructions of the software architecture 902, including implementation of the methods, modules, subsystems, and components, and so forth described herein and may also include memory and/or storage modules 910, which also have executable instructions 908. Hardware layer 904 may also comprise other hardware as indicated by other hardware 912 which represents any other hardware of the hardware layer 904, such as the other hardware illustrated as part of the software architecture 902.

In the example architecture of FIG. 9, the software architecture 902 may be conceptualized as a stack of layers where each layer provides particular functionality. For example, the software architecture 902 may include layers such as an operating system 914, libraries 916, frameworks/middleware 918, applications 920, and presentation layer 944. Operationally, the applications 920 and/or other components within the layers may invoke application programming interface (API) calls 924 through the software stack and access a response, returned values, and so forth illustrated as messages 926 in response to the API calls 924. The layers illustrated are representative in nature and not all software architectures have all layers. For example, some mobile or special purpose operating systems may not provide a frameworks/middleware 918 layer, while others may provide such a layer. Other software architectures may include additional or different layers.

The operating system 914 may manage hardware resources and provide common services. The operating system 914 may include, for example, a kernel 928, services 930, and drivers 932. The kernel 928 may act as an abstraction layer between the hardware and the other software layers. For example, the kernel 928 may be responsible for memory management, processor management (e.g., scheduling), component management, networking, security settings, and so on. The services 930 may provide other common services for the other software layers. In some examples, the services 930 include an interrupt service. The interrupt service may detect the receipt of an interrupt and, in response, cause the software architecture 902 to pause its current processing and execute an interrupt service routine (ISR) when an interrupt is accessed.

The drivers 932 may be responsible for controlling or interfacing with the underlying hardware. For instance, the drivers 932 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 916 may provide a common infrastructure that may be utilized by the applications 920 and/or other components and/or layers. The libraries 916 typically provide functionality that allows other software modules to perform tasks in an easier fashion than to interface directly with the underlying operating system 914 functionality (e.g., kernel 928, services 930 and/or drivers 932). The libraries 916 may include system libraries 934 (e.g., C standard library) that may provide functions such as memory allocation functions, string manipulation functions, mathematic functions, and the like. In addition, the libraries 916 may include API libraries 936 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 916 may also include a wide variety of other libraries 938 to provide many other APIs to the applications 920 and other software components/modules.

The frameworks/middleware 918 may provide a higher-level common infrastructure that may be utilized by the applications 920 and/or other software components/modules. For example, the frameworks/middleware 918 may provide various graphic user interface (GUI) functions, high-level resource management, high-level location services, and so forth. The frameworks/middleware 918 may provide a broad spectrum of other APIs that may be utilized by the applications 920 and/or other software components/modules, some of which may be specific to a particular operating system or platform.

The applications 920 include built-in applications 940 and/or third-party applications 942. Examples of representative built-in applications 940 may include, but are not limited to, a contacts application, a browser application, a book reader application, a location application, a media application, a messaging application, and/or a game application. Third-party applications 942 may include any of the built-in applications as well as a broad assortment of other applications. In a specific example, the third-party application 942 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 942 may invoke the API calls 924 provided by the mobile operating system such as operating system 914 to facilitate functionality described herein.

The applications 920 may utilize built in operating system functions (e.g., kernel 928, services 930 and/or drivers 932), libraries (e.g., system libraries 934, API libraries 936, and other libraries 938), and frameworks/middleware 918 to create user interfaces to interact with users of the system. Alternatively, or additionally, in some systems, interactions with a user may occur through a presentation layer, such as presentation layer 944. In these systems, the application/module “logic” can be separated from the aspects of the application/module that interact with a user.

Some software architectures utilize virtual machines. In the example of FIG. 9, this is illustrated by virtual machine 948. A virtual machine creates a software environment where applications/modules can execute as if they were executing on a hardware computing device. A virtual machine is hosted by a host operating system (operating system 914) and typically, although not always, has a virtual machine monitor 946, which manages the operation of the virtual machine 948 as well as the interface with the host operating system (i.e., operating system 914). A software architecture executes within the virtual machine 948 such as an operating system 950, libraries 952, frameworks/middleware 954, applications 956 and/or presentation layer 958. These layers of software architecture executing within the virtual machine 948 can be the same as corresponding layers previously described or may be different.

### Modules, Components and Logic

A computer system may include logic, components, modules, mechanisms, or any suitable combination thereof. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. One or more computer systems (e.g., a standalone, client, or server computer system) or one or more hardware processors may be configured by software (e.g., an application or application portion) as a hardware-implemented module that operates to perform certain operations as described herein.

A hardware-implemented module may be implemented mechanically or electronically. For example, a hardware-implemented module may comprise dedicated circuitry or logic that is permanently configured (e.g., as a special-purpose processor, such as a field programmable gate array [FPGA] or an application-specific integrated circuit [ASIC]) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Hardware-implemented modules may be temporarily configured (e.g., programmed), and each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). Multiple hardware-implemented modules are configured or instantiated at different times. Communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. The processor or processors may be located in a single location (e.g., within a home environment, an office environment, or a server farm), or the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

The systems and methods described herein may be implemented using digital electronic circuitry, computer hardware, firmware, software, a computer program product (e.g., a computer program tangibly embodied in an information carrier, e.g., in a machine-readable medium for execution by, or to control the operation of, data processing apparatus, e.g., a programmable processor, a computer, or multiple computers), or any suitable combination thereof.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites (e.g., cloud computing) and interconnected by a communication network. In cloud computing, the server-side functionality may be distributed across multiple computers connected by a network. Load balancers are used to distribute work between the multiple computers. Thus, a cloud computing environment performing a method is a system comprising the multiple processors of the multiple computers tasked with performing the operations of the method.

Operations may be performed by one or more programmable processors executing a computer program to perform functions by operating on input data and generating output. Method operations can also be performed by, and apparatus of systems may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. A programmable computing system may be deployed using hardware architecture, software architecture, or both. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out example hardware (e.g., machine) and software architectures that may be deployed.

### Example Machine Architecture and Machine-Readable Medium

FIG. 10 shows a block diagram of a machine in the example form of a computer system 1000 within which instructions 1024 may be executed for causing the machine to perform any one or more of the methodologies discussed herein. The machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU), or both), a main memory 1004, and a static memory 1006, which communicate with each other via a bus 1008. The computer system 1000 may further include a video display unit 1010 (e.g., a liquid crystal display (LCD) or a cathode ray tube [CRT]). The computer system 1000 also includes an alphanumeric input device 1012 (e.g., a keyboard or a touch-sensitive display screen), a user interface (UI) navigation (or cursor control) device 1014 (e.g., a mouse), a storage unit 1016, a signal generation device 1018 (e.g., a speaker), and a network interface device 1020.

### Machine-Readable Medium

The storage unit 1016 includes a machine-readable medium 1022 on which is stored one or more sets of data structures and instructions 1024 (e.g., software) embodying or utilized by any one or more of the methodologies or functions described herein. The instructions 1024 may also reside, completely or at least partially, within the main memory 1004 and/or within the processor 1002 during execution thereof by the computer system 1000, with the main memory 1004 and the processor 1002 also constituting a machine-readable medium 1022.

While the machine-readable medium 1022 is shown in FIG. 10 to be a single medium, the term “machine-readable medium” may include a single medium or multiple media (e.g., a centralized or distributed database, and/or associated caches and servers) that store the one or more instructions 1024 or data structures. The term “machine-readable medium” shall also be taken to include any tangible medium that is capable of storing, encoding, or carrying instructions 1024 for execution by the machine and that cause the machine to perform any one or more of the methodologies of the present disclosure, or that is capable of storing, encoding, or carrying data structures utilized by or associated with the instructions 1024. The term “machine-readable medium” shall accordingly be taken to include, but not be limited to, solid-state memories, and optical and magnetic media. Specific examples of machine-readable media include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

### Transmission Medium

The instructions 1024 may further be transmitted or received over a communications network 1026 using a transmission medium. The instructions 1024 may be transmitted using the network interface device 1020 and any one of a number of well-known transfer protocols (e.g., hypertext transport protocol [HTTP]). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 1024 for execution by the machine, and includes digital or analog communications signals or other intangible media to facilitate communication of such software.

Although specific examples are described herein, it will be evident that various modifications and changes may be made to these examples without departing from the broader spirit and scope of the disclosure. Accordingly, the specification and drawings are to be regarded in an illustrative rather than a restrictive sense. The accompanying drawings that form a part hereof show by way of illustration, and not of limitation, specific examples in which the subject matter may be practiced. The examples illustrated are described in sufficient detail to enable those skilled in the art to practice the teachings disclosed herein.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance. Finally, as used herein, the conjunction “or” refers to a non-exclusive “or,” unless specifically stated otherwise.

What is claimed is:

1. A system comprising:
a memory that stores instructions; and
one or more processors coupled to the memory and configured to execute the instructions to perform operations comprising:
generating a prompt comprising general instructions, an output schema comprising a set of fields, and unstructured data comprising values for a strict subset of the set of fields; and
training a large language model (LLM) to generate structured data from unstructured data using a training set comprising a plurality of training prompts, the plurality of training prompts including the generated prompt.

2. The system of claim 1, wherein the operations further comprise:
accessing a pre-determined number of positive fields to include in the output schema; and
accessing a pre-determined number of negative fields to exclude from the output schema.

3. The system of claim 2, wherein the operations further comprise:
generating a plurality of additional training prompts, each training prompt of the plurality of additional training prompts comprising general instructions, an output schema comprising a set of fields, and unstructured data comprising values for the pre-determined number of positive fields and excluding values for the pre-determined number of negative fields; and
including the plurality of additional training prompts in the plurality of training prompts.

4. The system of claim 3, wherein the operations further comprise:
randomly selecting, for each training prompt of the plurality of additional training prompts, from the set of fields, the pre-determined number of positive fields to include.

5. The system of claim 1, wherein the operations further comprise:
generating a plurality of additional training prompts, by operations comprising, for each training prompt of the plurality of additional training prompts:
determining, according to a probability distribution, a number of positive fields to include and a number of negative fields to exclude; and
generating the training prompt of the plurality of additional training prompts to include general instructions, an output schema comprising a set of fields, and unstructured data comprising values for the determined number of positive fields and excluding values for the determined number of negative fields; and
including the plurality of additional training prompts in the plurality of training prompts.

6. The system of claim 5, wherein the probability distribution is a Poisson distribution.

7. The system of claim 1, wherein the training of the LLM uses a loss function that masks the training prompts from learning.

8. A non-transitory computer-readable medium that stores instructions that, when executed by one or more processors, cause the one or more processors to perform operations comprising:
generating a prompt comprising general instructions, an output schema comprising a set of fields, and unstructured data comprising values for a strict subset of the set of fields; and
training a large language model (LLM) to generate structured data from unstructured data using a training set comprising a plurality of training prompts, the plurality of training prompts including the generated prompt.

9. The non-transitory computer-readable medium of claim 8, wherein the operations further comprise:
accessing a pre-determined number of positive fields to include in the output schema; and
accessing a pre-determined number of negative fields to exclude from the output schema.

10. The non-transitory computer-readable medium of claim 9, wherein the operations further comprise:
generating a plurality of additional training prompts, each training prompt of the plurality of additional training prompts comprising general instructions, an output schema comprising a set of fields, and unstructured data comprising values for the pre-determined number of positive fields and excluding values for the pre-determined number of negative fields; and
including the plurality of additional training prompts in the plurality of training prompts.

11. The non-transitory computer-readable medium of claim 10, wherein the operations further comprise:
randomly selecting, for each training prompt of the plurality of additional training prompts, from the set of fields, the pre-determined number of positive fields to include.

12. The non-transitory computer-readable medium of claim 8, wherein the operations further comprise:
generating a plurality of additional training prompts, by operations comprising, for each training prompt of the plurality of additional training prompts:
determining, according to a probability distribution, a number of positive fields to include and a number of negative fields to exclude; and
generating the training prompt of the plurality of additional training prompts to include general instructions, an output schema comprising a set of fields, and unstructured data comprising values for the determined number of positive fields and excluding values for the determined number of negative fields; and
including the plurality of additional training prompts in the plurality of training prompts.

13. The non-transitory computer-readable medium of claim 12, wherein the probability distribution is a Poisson distribution.

14. The non-transitory computer-readable medium of claim 8, wherein the training of the LLM uses a loss function that masks the training prompts from learning.

15. A method comprising:
generating, by one or more processors, a prompt comprising general instructions, an output schema comprising a set of fields, and unstructured data comprising values for a strict subset of the set of fields; and
training a large language model (LLM) to generate structured data from unstructured data using a training set comprising a plurality of training prompts, the plurality of training prompts including the generated prompt.

16. The method of claim 15, further comprising:
accessing a pre-determined number of positive fields to include in the output schema; and
accessing a pre-determined number of negative fields to exclude from the output schema.

17. The method of claim 16, further comprising:
generating a plurality of additional training prompts, each training prompt of the plurality of additional training prompts comprising general instructions, an output schema comprising a set of fields, and unstructured data comprising values for the pre-determined number of positive fields and excluding values for the pre-determined number of negative fields; and
including the plurality of additional training prompts in the plurality of training prompts.

18. The method of claim 17, further comprising:
randomly selecting, for each training prompt of the plurality of additional training prompts, from the set of fields, the pre-determined number of positive fields to include.

19. The method of claim 15, further comprising:
generating a plurality of additional training prompts, by operations comprising, for each training prompt of the plurality of additional training prompts:
determining, according to a probability distribution, a number of positive fields to include and a number of negative fields to exclude; and
generating the training prompt of the plurality of additional training prompts to include general instructions, an output schema comprising a set of fields, and unstructured data comprising values for the determined number of positive fields and excluding values for the determined number of negative fields; and
including the plurality of additional training prompts in the plurality of training prompts.

20. The method of claim 19, wherein the probability distribution is a Poisson distribution.
